(19) United States
(12) Patent Application Publication
(10) Pub. No.: US 2025/0011532 A1
(43) Pub. Date: Jan. 9, 2025

(54) MODIFIED POLYESTER COMPOSITION AND MANUFACTURING METHOD THEREOF

(71) Applicant: NAN YA PLASTICS CORPORATION, TAIPEI (TW)

(72) Inventors: Te-Chao Liao, TAIPEI (TW); Chun-Che Tsao, TAIPEI (TW); Yueh-Shin Liu, TAIPEI (TW)

(73) Assignee: NAN YA PLASTICS CORPORATION, TAIPEI (TW)

(21) Appl. No.: 18/465,986

(22) Filed: Sep. 13, 2023

(30) Foreign Application Priority Data
Jul. 6, 2023 (TW) 112125352
Aug. 24, 2023 (TW) 112131968

(51) Int. Cl. C08G 63/183; C08K 3/22; C08K 3/26; C08K 3/36; C08K 5/098; C08K 7/06; C08K 7/14; C08L 23/08; C08L 67/02

(52) U.S. Cl. CPC C08G 63/183; C08K 3/22; C08K 3/26; C08K 3/36; C08K 5/098; C08K 7/06; C08K 7/14; C08L 23/0869; C08L 67/02; C08K 2003/2241; C08K 2003/265; C08L 2205/24; C08L 2207/20

(57) ABSTRACT

A modified polyester composition, including modified polyester and a filler material, is provided. The modified polyester includes a polyester material, a nucleating agent, and an antioxidant. The polyester material includes a macromolecule of polyethylene terephthalate. The content of the nucleating agent in the modified polyester is 0.5 wt % to 3 wt %.

### CROSS-REFERENCE TO RELATED APPLICATION

This application claims the priority benefit of Taiwan application serial no. 112125352, filed on Jul. 6, 2023, and Taiwan application serial no. 112131968, filed on Aug. 24, 2023. The entirety of each of the above-mentioned patent applications is hereby incorporated by reference herein and made a part of this specification.

### BACKGROUND

### Technical Field

The invention relates to a modified polyester composition and a manufacturing method thereof.

### Description of Related Art

With the improvement of environmental protection awareness, the recycling of plastic products has attracted increasing attention. At present, many clothes use polyethylene terephthalate (PET) as a fiber material in the production process together with zippers or buttons made of polyoxymethylene (POM) or nylon. However, since PET is a different plastic material from POM or nylon, elements such as zippers or buttons need to be manually disassembled during the recycling process to separate the PET material from clothes, which increases the difficulty of recycling.

Since PET fibers are tightly bound to zippers or buttons, delicate and time-consuming manual operations are required to ensure effective separation of different plastic materials. Such a disassembly process not only increases labor costs, but also reduces recycling efficiency and benefits. In addition, failure to properly disassemble and sort these elements may result in the mixing of different plastic materials, further affecting the reuse of resources after recycling.

### SUMMARY

At least one embodiment of the invention provides a manufacturing method of a modified polyester composition, including the following steps. A polyester material is provided. The polyester material includes a macromolecule of polyethylene terephthalate and an oligomer of polyethylene terephthalate, and an intrinsic viscosity (IV) of the polyester material is between 0.5 dL/g and 0.6 dL/g. A heating and decompression process is performed on the polyester material to reduce the oligomer of polyethylene terephthalate in the polyester material and increases the intrinsic viscosity of the polyester material to between 0.6 dL/g and 0.92 dL/g. A nucleating agent, an antioxidant, and a filler material are mixed into the polyester material, and a crystallinity of the polyester material is increased to obtain the modified polyester composition including modified polyester and the filler material. A content of the nucleating agent in the modified polyester composition is 0.5 wt % to 3 wt %, and a crystallinity of the modified polyester is 15% to 28% at 23° C.

At least one embodiment of the invention provides a modified polyester composition, including modified polyester and a filler material. The modified polyester includes a polyester material, a nucleating agent, and an antioxidant. The polyester material includes a macromolecule of polyethylene terephthalate. The polyester material has an intrinsic viscosity of between 0.6 dL/g and 0.92 dL/g before mixing with the nucleating agent. A content of the nucleating agent in the modified polyester composition is 0.5 wt % to 3 wt %, and a crystallinity of the modified polyester is 15% to 28% at 23° C.

### DESCRIPTION OF THE EMBODIMENTS

In the following, embodiments of the invention will be described in detail. However, these embodiments are illustrative, and the invention is not limited thereto.

Herein, a range indicated by “a numerical value to another numerical value” is a general representation which avoids enumerating all numerical values in the range in the specification. Therefore, the description of a specific numerical range covers arbitrary numerical values in the numerical range and a smaller numerical range defined by arbitrary numerical values in the numerical range, as if the arbitrary numerical values and the smaller numerical range are written in the specification.

The invention provides a manufacturing method of a modified polyester composition. First, a polyester material is provided. In some embodiments, polyethylene terephthalate (PET) in the polyester material may include virgin polyester resin, recycled polyester, or a combination thereof. The virgin polyester resin is generally existing new polyester. The recycled polyester may include physically recycled polyester and/or chemically recycled polyester.

For example, an obtaining method of the recycled polyester includes collecting various types of waste polyester resin materials. Classification is carried out according to types, colors, and uses of the waste polyester resin materials. Moreover, the waste polyester resin materials are compressed, packaged, and then transported to a waste treatment plant.

In some embodiments, the waste polyester resin materials are recycled PET bottles, film materials, fibers, etc., but the invention is not limited thereto. Other components (such as bottle caps, labels, and adhesives) on the waste polyester resin materials are removed. Next, the waste polyester resin materials are cut and crushed, and bottle necks, liners, and bottle bodies of different materials in the PET bottles are separated using methods such as flotation. Moreover, the crushed waste polyester resin materials are dried to obtain a processed recycled polyester material (i.e. recycled polyethylene terephthalate (r-PET)), so as to facilitate the subsequent manufacturing process.

The recycled polyester material is further processed to obtain recycled polyester resin. The recycled polyester resin may be physically recycled polyester resin or chemically recycled polyester resin.

In some embodiments, the physically recycled polyester resin refers to polyester resin obtained by physical reproduction and includes physically recycled conventional polyester resin and physically recycled modified polyester resin. The physically recycled conventional polyester resin is not added with any functional additives during the recycling process, and the physically recycled modified polyester resin is added with functional additives (such as a slip agent, a colorant, a weather-resistant modifier, a nucleating agent, and a fogging agent) to prepare the physically recycled modified polyester resins with different functions.

In some embodiments, the manufacturing method of the chemically recycled polyester resin includes cutting the recycled polyester materials (for example, flakes of PET bottles) and putting the cut flakes into a chemical depolymerization solution, so that chains of polyester molecules in the recycled polyester materials are broken, so as to achieve the effect of depolymerizing the recycled polyester materials, and a polyester composition with a shorter molecular chain and an ester monomer, such as bis-hydroxyethyl terephthalate (BHET), composed of a diacid unit and two diol units can be further obtained. Next, an oligomer mixture is separated and purified, and then the oligomer mixture is repolymerized to obtain the chemically recycled polyester resin. In some embodiments, in the process of chemical reproduction, functional additives (such as the slip agent, the colorant, the weather-resistant modifier, the nucleating agent, and the fogging agent) may also be added to the oligomer mixture, and then repolymerization is carried out to obtain the chemically recycled modified polyester resins with different functions.

Before modification is carried out, the polyester material composed of the virgin polyester resin and/or the recycled polyester includes a macromolecule of PET and an oligomer of PET, and has the intrinsic viscosity of between 0.5 dL/g and 0.6 dL/g. In addition, before modification is carried out, PET in the polyester material has a melting point of 242 degrees Celsius to 252 degrees Celsius. In some embodiments, before modification is carried out, PET in the polyester material has the crystallinity of 5% to 15% at a normal temperature (about 230 C). In some embodiments, before modification is carried out, the cooling crystallization temperature (Tcc) of the polyester material is from 160° C. to 185° C., and the heating crystallization temperature (The) is from 105° C. to 135° C.

Next, the polyester material is modified to obtain modified polyester. Specifically, modifying the polyester material includes performing a heating and decompression process on the polyester material, and mixing additives such as the nucleating agent, the antioxidant, and the filler material into the polyester material. The details are as follows.

The heating and decompression process is performed on the polyester material to reduce the oligomer of PET in the polyester material. Thereby, tackification of the polyester material is carried out. A method for the tackification includes solid state tackification and/or liquid state tackification. For example, the polyester material including the macromolecule of PET and the oligomer of PET is put into a chamber, and the chamber is depressurized and heated to volatilize the oligomer of PET. In some embodiments, the polyester material is heated to 190° C. to 220° C., depressurized to 0.01 kPa to 0.05 kPa, and subjected to solid state polymerization for 6 hours to 10 hours. Due to the reduced content of the oligomer, the intrinsic viscosity of the polyester material can be increased to be between 0.6 dL/g and 0.92 dL/g, preferably between 0.8 dL/g and 0.92 dL/g.

The nucleating agent, the antioxidant, and the filler material are mixed into the polyester material. The nucleating agent can increase the crystallization rate, thereby enabling the subsequently obtained modified polyester to have high crystallinity. In some embodiments, the nucleating agent includes an organic nucleating agent, an inorganic nucleating agent, or a combination of both. The organic nucleating agent is selected from at least one of the following materials: sodium benzoate, sodium montanate, sodium salt copolymer of ethylene-methyl methacrylate (EMMA-sodium salt, also known as surlyn), and other organic sodium salts, and the inorganic nucleating agent is selected from at least one of the following materials: talcum powder, titanium dioxide, silicon dioxide, calcium carbonate, and other inorganic micro-nano powders. The particle size of the inorganic nucleating agent used as the nucleating agent is less than 2 m. For example, the average particle diameter of the inorganic nucleating agent is 500 nm to 1500 nm. In some embodiments, the content of the nucleating agent in the finally obtained modified polyester composition is 0.5 wt % to 3 wt %, preferably 1 wt % to 2 wt %.

In some embodiments, the antioxidant is selected from at least one of the following materials: hindered phenolic antioxidants, phenolic antioxidants, mixed antioxidants, and phosphite antioxidants. In some embodiments, the content of the antioxidant in the finally obtained modified polyester composition is 0.1 wt % to 1 wt %, such as 0.2 wt % to 0.8 wt % or 0.4 wt % to 0.6 wt %.

In some embodiments, the filler material is selected from at least one of the following materials: glass fiber, carbon fiber, metal oxide, silicon dioxide, and so on. In some embodiments, the content of the filler material in the finally obtained modified polyester composition is 0.5 wt % to 50 wt %, such as 10 wt % to 40 wt % or 20 wt % to 30 wt %. In some embodiments, the filler material is fibrous or granular. When the filler material is granular, the average particle diameter is 5 μm to 50 μm.

In some embodiments, the nucleating agent, the antioxidant, the filler material, and an unmodified polyester material are added into a twin-screw extruder for mixing, and the modified polyester composition may be obtained after extrusion. In some embodiments, the nucleating agent, the antioxidant, and the filler material are mixed into the polyester material at 260° C. to 280° C. In some embodiments, other additives such as a flow slip agent, a dye, and a color masterbatch may also be mixed into the polyester material.

In some embodiments, the crystallinity of the modified polyester composition at 23° C. is 15% to 28%. In some embodiments, the cooling crystallization temperature (Tcc) of the modified polyester composition is 190° C. to 210° C., and the heating crystallization temperature (The) is 100° C. to 130° C. In some embodiments, the tensile strength of the modified polyester composition is 60 MPa to 90 MPa. In some embodiments, the melting point of the modified polyester composition is 245° C. to 255° C.

In order to prove that the modified polyester composition proposed by the invention has excellent heat resistance and excellent mechanical strength, Table 1 presents the mechanical properties and the thermal properties of some experimental examples and comparative examples. In Comparative Example 3 and Experimental Example 2, the filler material is spherical (talcum powder) with a particle size of about 5 m. In Experimental Example 3, the glass fiber is fibrous (or rod-shaped) with a fiber diameter of about 10 m to 13 m. An organic sodium benzoate nucleating agent was added in Experimental Example 1. An inorganic talcum powder nucleating agent was mainly added in Experimental Example 2 and Experimental Example 3.

TABLE 1

| | | | | | | Experimental | |
|---|---|---|---|---|---|---|---|
| | | | | | | Example 2 | Experimental |
| | | | | Comparative | Experimental | Modified PET | Example 3 |
| | | | Comparative | Example 3 | Example 1 | (84 wt % of | Modified PET |
| | | | Example 2 | Modified PET | Modified PET | PET + 1 wt % | (89 wt % of |
| | | | Unmodified | (84 wt % of | (98 wt % of | of nucleating | PET + 1 wt % |
| | | Comparative | PET (no | PET + 16 | PET + 2% of | agent + 15 | of nucleating |
| | | Example 1 | nucleating | wt % of filler | nucleating | wt % of filler | agent + 10 wt % |
| Composition | | POM | agent added) | material) | agent) | material) | of glass fiber) |
| Mechanical | Impact | 4.0 | 3.5 | 3.9 | 3.8 | 3.5 | 4.6 |
| property | strength (kg- | | | | | | |
| | cm/cm) | | | | | | |
| | Tensile | 62 | 58 | 57 | 61.7 | 60.1 | 85.2 |
| | strength | | | | | | |
| | (MPa) | | | | | | |
| | Flexural | 2450 | 2350 | 2650 | 2430 | 2980 | 4130 |
| | modulus | | | | | | |
| | (MPa) | | | | | | |
| | Heat | 108 | 68 | 81 | 78 | 97 | 152 |
| | deflection | | | | | | |
| | temperature | | | | | | |
| | under 0.45 | | | | | | |
| | Mpa (° C.) | | | | | | |
| Thermal | Crystallinity | — | 8.5 | 19.3 | 17.2 | 24.8 | 27.9 |
| property | (%) | | | | | | |
| | Cooling | 140 | 165 | 188 | 192 | 202 | 205 |
| | crystallization | | | | | | |
| | temperature | | | | | | |
| | (° C.) | | | | | | |
| | Heating | — | 120 | 120 | 118 | 118 | 115 |
| | crystallization | | | | | | |
| | temperature | | | | | | |
| | (° C.) | | | | | | |
| | Melting point | 175 | 248 | 248 | 249 | 250 | 252 |
| | (° C.) | | | | | | |

From Comparative Example 2 and Experimental Example 1, it can be seen that impact strength, tensile strength, flexural modulus, and heat deflection temperature of polyester can be improved through the addition of the nucleating agent. In addition, from Experimental Example 1 to Experimental Example 3, it can be seen that the flexural modulus and heat deflection temperature of the polyester can be increased through the addition of the filler material, wherein Experimental Example 3 with the addition of the glass fiber is preferred.

What is claimed is:

1. A manufacturing method of a modified polyester composition, comprising:
providing a polyester material, wherein the polyester material comprises a macromolecule of polyethylene terephthalate and an oligomer of polyethylene terephthalate, and an intrinsic viscosity of the polyester material is between 0.5 dL/g and 0.6 dL/g;
performing a heating and decompression process on the polyester material to reduce the oligomer of polyethylene terephthalate in the polyester material and increase the intrinsic viscosity of the polyester material to between 0.6 dL/g and 0.92 dL/g;
mixing a nucleating agent, an antioxidant, and a filler material into the polyester material, and increasing a crystallinity of the polyester material to obtain modified polyester and the modified polyester composition of the filler material, wherein a content of the nucleating agent in the modified polyester composition is 0.5 wt % to 3 wt %, and a crystallinity of the modified polyester is 15% to 28% at 23° C.

2. The manufacturing method of the modified polyester composition according to claim 1, wherein a content of the antioxidant in the modified polyester composition is 0.1 wt % to 1 wt %, and a content of the filler material in the modified polyester composition is 0.5 wt % to 50 wt %.

3. The manufacturing method of the modified polyester composition according to claim 1, wherein the nucleating agent comprises an organic nucleating agent, an inorganic nucleating agent, or a combination of both.

4. The manufacturing method of the modified polyester composition according to claim 3, wherein the organic nucleating agent is selected from at least one of following materials: sodium benzoate, sodium montanate, and sodium salt copolymer of ethylene-methyl methacrylate, and the inorganic nucleating agent is selected from at least one of following materials: talcum powder, titanium dioxide, silicon dioxide, and calcium carbonate, wherein the filler material is selected from at least one of following materials: glass fiber, carbon fiber, metal oxide, and silicon dioxide.

5. The manufacturing method of the modified polyester composition according to claim 1, wherein the nucleating agent, the antioxidant, and the filler material are mixed into the polyester material at 260° C. to 280° C.

6. A modified polyester composition, comprising:
modified polyester and a filler material, the modified polyester comprising a polyester material, a nucleating agent, and an antioxidant, wherein the polyester material comprises a macromolecule of polyethylene terephthalate, wherein an intrinsic viscosity of the polyester material before mixing with the nucleating agent is between 0.6 dL/g and 0.92 dL/g, wherein a content of the nucleating agent in the modified polyester composition is 0.5 wt % to 3 wt %, and a crystallinity of the modified polyester is 15% to 28% at 23° C.

7. The modified polyester composition according to claim 6, wherein a content of the antioxidant in the modified polyester composition is 0.1 wt % to 1 wt %, and a content of the filler material in the modified polyester composition is 0.5 wt % to 50 wt %.

8. The modified polyester composition according to claim 6, wherein the nucleating agent comprises an organic nucleating agent, an inorganic nucleating agent, or a combination of both, wherein the organic nucleating agent is selected from at least one of following materials: sodium benzoate, sodium montanate, and sodium salt copolymer of ethylene-methyl methacrylate, and the inorganic nucleating agent is selected from at least one of following materials: talcum powder, titanium dioxide, silicon dioxide, and calcium carbonate.

9. The modified polyester composition according to claim 6, wherein the filler material is selected from at least one of following materials: glass fiber, carbon fiber, metal oxide, and silicon dioxide.
